(19) United States
(12) Patent Application Publication
(10) Pub. No.: US 2021/0279967 A1
(43) Pub. Date: Sep. 9, 2021

(54) OBJECT CENTRIC SCANNING

(71) Applicant: Apple Inc., Cupertino, CA (US)

(72) Inventors: Thorsten Gernoth, San Francisco, CA (US); Chen Huang, Columbia, MS (US); Onur C. Hamsici, Cupertino, CA (US); Shuo Feng, San Jose, CA (US); Hao Tang, San Jose, CA (US); Tobias Rick, Mountain View, CA (US)

(21) Appl. No.: 17/179,487

(22) Filed: Feb. 19, 2021

Related U.S. Application Data
(60) Provisional application No. 62/986,076, filed on Mar. 6, 2020.

(51) Int. Cl. G06T 19/00; G06T 7/20; G06K 9/00; G06F 3/0481; G06F 9/451

(52) U.S. Cl. CPC G06T 19/006; G06T 7/20; G06F 9/453; G06K 9/00664; G06F 3/04815; G06K 9/00201

(57) ABSTRACT

Various implementations disclosed herein include devices, systems, and methods that generates a three-dimensional (3D) model of an object based on images and tracked positions of a device during acquisition of the images. For example, an example process may include acquiring sensor data during movement of the device in a physical environment including an object, the sensor data including images of a physical environment acquired via a camera on the device, identifying the object in at least some of the images, tracking positions of the device during acquisition of the images based on identifying the object in the at least some of the images, the positions identifying positioning of the device with respect to a coordinate system defined based on a position and orientation of the object, and generating a 3D model of the object based on the images and positions of the device during acquisition of the images.

### CROSS-REFERENCE TO RELATED APPLICATIONS

This application claims the benefit of U.S. Provisional Application Ser. No. 62/986,076 filed Mar. 6, 2020, which is incorporated herein in its entirety.

### TECHNICAL FIELD

The present disclosure generally relates to generating three-dimensional geometric representations of physical environments, and in particular, to systems, methods, and devices that generate geometric representations based on depth information detected in physical environments.

### BACKGROUND

Physical environments and objects therein have been modeled (e.g., reconstructed) by generating three-dimensional (3D) meshes, utilizing 3D point clouds, and by other means. The reconstructed meshes represent 3D surface points and other surface characteristics of the physical environments' floors, walls, and other objects. Such reconstructions may be generated based on images and depth measurements of the physical environments, e.g., using RGB cameras and depth sensors.

Existing techniques for generating 3D models based on images of a physical environment and depth information detected in the physical environment may be inaccurate and inefficient using a mobile device, for example, based on a user capturing photos or video or other sensor data while walking about in a room. Moreover, existing techniques may fail to provide sufficiently accurate and efficient object detection in real time environments.

### SUMMARY

Various implementations disclosed herein include devices, systems, and methods that generate a three-dimensional (3D) model of an object based on images and positions of a device during acquisition of the images. The 3D model is generated based on images of a physical environment, depth information detected in the physical environment, and other information for tracking the devices/depth camera's particular position and orientation (e.g., camera pose). It may be desirable to utilize a camera pose that is object centric, e.g., defined in terms of an object-based coordinate system. In other words, constrained poses are tied to a target object (e.g., a single object of interest), and position is relative to the target object. Doing so may provide a more useful, realistic, or physically meaningful model of an object.

Some implementations of this disclosure involve an exemplary method of generating a 3D model of an object based on images and positions of a device during acquisition of the images. The exemplary method initially involves acquiring sensor data during movement of the device in a physical environment including an object, the sensor data including images of a physical environment acquired via a camera on the device. For example, a user moves a device (e.g., a mobile device) around an object (e.g., a shoe on top of a table) in a physical environment to acquire images of the object from different sides. In some implementations, the sensor data may include depth data and motion sensor data. In some implementations, during movement of the device, a user interface may display the acquired environment that includes the object and provide a user interface element. For example, a user interface element (e.g., an extended reality image, such as a 3D arrow overlaid on a live video stream) can show a user additional angles and/or perspectives to acquire the object. In some implementations, the user interface can display a preliminary 3D model of the object (e.g., a 3D mesh, 3D bounding box, etc.). For example, a picture-in-picture display of another window can display to the user a 3D model reconstruction in a live preview screen as the user is capturing live video and as the live video is streaming on the main viewing screen.

The exemplary method further involves identifying the object in at least some of the images. For example, identifying the object may involve identifying the object using a preliminary object model based on information from multiple images and depth information. Identifying the object using a preliminary object model may involve masking by creating a 3D bounding box corresponding to the object. Additionally, or alternatively, a two-dimensional (2D) mask corresponding to the object can also be created. During image acquisition, the 3D bounding box is adjusted to fit the object better to define the object of interest and separate from the background. In some implementations, object identification may be based on cropping/resizing the preliminary object model and the 3D keypoints associated with the preliminary object model. For example, using a 3D bounding box constraint to remove background pixels located outside of the 3D bounding box, and/or using a 2D mask constraint to remove background pixels located outside of a 2D mask associated with the object. The masking (e.g., cropping/resizing the preliminary object model) can occur during scanning (e.g., during image acquisition) to detect the object in a first stage and then when doing the image scanning, those masks (e.g., 3D bounding box constraint, 2D mask, etc.) are used to separate out the object by removing background pixels. In some implementations, the masking can use a coverage algorithm and go around the object and compute on the fly positions during image acquisition.

In some implementations, object identification can involve densification of a sparse 3D depth cloud. For example, creating a dense 3D depth cloud from sparse data sets using a densification algorithm. Additionally, or alternatively, in some implementations, object identification can involve keypoint interpolation and/or exclusion of keypoints close to depth edges. For example, using a keypoint object algorithm, keypoints of an object are identified (e.g., semantic labeling of an RGB image via a neural network) and additional keypoints (e.g., additional pixels associated with the object) can be interpolated (e.g., added) to the preliminary object model, or excluded (e.g., removed) from the preliminary object model.

The exemplary method further involves tracking positions of the device during acquisition of the images based on the identifying of the object in the at least some of the images, the positions identifying positioning and/or orientation (e.g., pose information) of the device with respect to a coordinate system defined based on a position and an orientation of the object. In an exemplary implementation, tracking positions of the device during acquisition of the images based on the identifying of the object tracks the object by updating an object-centric pose of the device, e.g., where the camera is relative to the object in object-based coordinates when each of the images is acquired. In some implementations, the tracking can use a pose graph defined in the object-based coordinates (e.g., a historical record made of the relative RGB-D camera movement).

In some implementations, tracking may involve re-localizing when the object goes out of view or when previously unseen portion of the object is acquired. For example, when an object is taken away from the camera view and flipped over, the tracking may need to re-localize and further identify the object as the same object of interest and recalibrate the object centric coordinates to determine the flipped object is the same object of interest. In some implementations, the method may iteratively update both the camera's object centric pose and the preliminary object model.

In some implementations, the poses may be verified based on cropping/resizing the preliminary object model and its 3D keypoints, for example, using a 3D bounding box constraint to remove background image information and/or a 2D mask to remove background image pixels (e.g., similar to the process described above for the masking during the object identification phase). In some implementations, pose verification may further involve densification of a sparse depth cloud, keypoint interpolation, and/or exclusion of keypoints close to depth edges.

The exemplary method further involves generating a 3D model of the object based on the images and positions of the device during acquisition of the images. The 3D model may be based on refined/cropped images, associated depth info, and the relative locations of the camera associated with such images and depth information. The 3D model may be a 3D mesh representation or a 3D point cloud. In some implementations, the 3D model data could be a 3D representation representing the surfaces in a 3D environment using a 3D point cloud with associated semantic labels. In some implementations, the 3D model data is a 3D reconstruction mesh using a meshing algorithm based on depth information detected in the generated environment that is integrated (e.g., fused) to recreate the physical environment. A meshing algorithm (e.g., a dual marching cubes meshing algorithm, a poisson meshing algorithm, a tetrahedral meshing algorithm, or the like) can be used to generate a mesh representing a room and/or object(s) within a room (e.g., furniture, statue of a dog on a table, a chair, etc.).

In some implementations, acquiring the sensor data during the movement of the device includes acquiring images from different perspectives of the object as the device is moved around the object.

In some implementations, a user interface may display extended reality images with plus signs or other virtual indicators (e.g., a pointer or arrow) positioned in 3D space to guide the user to position the device at appropriate positions and orientations to acquire appropriate images of the object. Since the tracking is object-centric, if the object moves, the indicators will move too with respect to the position and orientation of the object.

In some implementations, identifying the object includes generating a preliminary object model based on depth information from the images of the physical environment, where the preliminary object model includes 3D keypoints corresponding to the object. In some implementations, the preliminary object model is a 3D bounding box, and generating a 3D bounding box includes an exemplary method of obtaining a 3D representation (e.g., 3D semantic point cloud) of the physical environment that was generated based on the depth data, and generating the 3D bounding box corresponding to the object in the physical environment based on the 3D representation. In some implementations, generating a 3D bounding box includes an exemplary method of obtaining a 3D representation of the physical environment that was generated based on the depth data, determining a ground plane corresponding to the object in the physical environment based on the 3D representation, and generating the 3D bounding box corresponding to the object in the physical environment based on the ground plane and the 3D representation.

In some implementations, identifying the object further includes adjusting (e.g., cropping and/or resizing) the preliminary object model based on the 3D keypoints corresponding to the object. In some implementations, adjusting the preliminary object model is based on a 3D bounding box constraint used to remove background information included in the 3D bounding box to generate an updated 3D bounding box. In some implementations, the depth information includes a sparse 3D point cloud, wherein identifying the object further includes densification of the sparse 3D point cloud based on the 3D keypoints corresponding to the object.

In some implementations, identifying the object further includes keypoint interpolation of the 3D keypoints corresponding to the object. In some implementations, keypoint interpolation includes exclusion of 3D keypoints that are within a proximity range of depth edges of the object.

In some implementations, the tracked positions of the device identify position and orientation of the device with respect to the coordinate system defined based on the position and the orientation of the object. In some implementations, tracking the positions of the device includes determining a pose graph based on the coordinate system. For example, a historical record can be made of the relative RGB-D camera movement, which is called a pose graph. For example, keyframes can be assigned or positioned along the pose graph and a current camera position can be shown relative to the pose graph.

In some implementations, device position criteria is determined based on the geometry of the target object and the acquired data of the target object. For example, the system identifies the object from an initial camera position, and the device position criteria can determine or estimate (e.g., driven by the backend reconstruction requirements) the number of additional view and device positions that may be required to acquire sufficient image date to optimally reconstruct the target object completely and accurately to minimize the number of viewing positions or stations needed to make it easier for the user and less data for the local device to process and/or send to a server to process.

In some implementations, the device includes a user interface, and tracking positions of the device during acquisition of the images includes displaying guiding indicators (e.g., extended reality images such as plus signs positioned in 3D space) on the user interface to guide a user to move the device at a new position (and/or orientation) to acquire additional images of the object at the new position. In some implementations, the guiding indicators guide the user to move the device to the new position and a new orientation. In some implementations, the guiding indicators are positioned in 3D space in a live camera view of the device. In some implementations, when the object moves within a field of view of the camera of the device, the guiding indicators move with respect to the object based on an adjusted coordinate system defined based on an adjusted position and an adjusted orientation of the object, wherein the adjusted position and the adjusted orientation of the object are based on the movement of the object.

In some implementations, tracking the positions of the device includes adjusting the images of the physical environment using a 2D mask to remove background image pixels of the images, wherein the 2D mask is determined based on the coordinate system of the object. For example, determining a 2D mask for an object can include accumulating a 3D point cloud, detecting planes of the 3D point cloud corresponding to the object, remove the detected plane points, using a 2D mask algorithm for point cloud clustering, get points belonging to the object, and then perform a convex hull process to get the 2D mask.

In some implementations, the tracking the positions of the device includes adjusting the images of the physical environment using a 3D bounding box constraint to remove background image pixels of the images, wherein the 3D bounding box constraint is determined based on the coordinate system of the object.

In some implementations, the sensor data includes depth information that includes a sparse 3D point cloud for each image, wherein tracking the positions of the device includes adjusting the images of the physical environment based on a densification of the sparse 3D point clouds based on 3D keypoints corresponding to the object.

In some implementations, the exemplary method further involves flipping the object and switching between regular pose estimation mode (e.g., used if the object is flipped within a field of view of the camera), and a re-localization mode (e.g., used if the object is flipped outside of a field of view of the camera). For example, in some implementations, the exemplary method further involves, when the object is reoriented or repositioned within a field of view of the camera, the method further includes a re-localization process, the re-localization process including comparing a first image of the physical environment with a plurality of keyframe images of the object, the first image including the object, and identifying a first keyframe from the plurality of keyframes based on the comparing, the keyframe associated with a first keyframe position in the coordinate system, and based on identifying the first keyframe, determining a re-localized position of the device with respect to the coordinate system of the object during acquisition of the first image based on the first keyframe position. For example, identifying matching 3D features of the object in the first image and the identified keyframe. In some implementations, the object is reoriented or repositioned within the field of view of the camera following a period in which the object is not within the field of view of the camera.

In some implementations, the generated 3D model of the object is determined based on refined images, wherein the refined images are determined based on at least one of a 3D keypoint interpolation, densification of 3D sparse point clouds associated with the images, a 2D mask corresponding to the object to remove background image pixels of the images, a 3D bounding box constraint corresponding to the object to remove background image pixels of the images. In some implementations, the 3D keypoint interpolation, the densification of the 3D sparse point clouds, the 2D mask, and the 3D bounding box constraint are based on the coordinate system of the object.

In some implementations, the generated 3D model of the object is based on generating a mesh, a 3D point cloud, or a voxel representation of the object. In some implementations, the sensor data includes depth data (e.g., RGB-D) and light intensity image data (e.g., RGB) of the physical environment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example server in accordance with some implementations.

FIG. 3 is a block diagram of an example device in accordance with some implementations.

FIG. 4 is a flowchart representation of an exemplary method that generates a three-dimensional (3D) model of an object based on images and tracked positions of the device during acquisition of the images in accordance with some implementations.

FIG. 5A is a block diagram illustrating example positions of a camera with respect to an object in a physical environment in accordance with some implementations.

FIG. 5B is a block diagram illustrating example user interface with respect to different positions of a camera with respect to an object in a physical environment in accordance with some implementations.

FIGS. 6A-6D are block diagrams illustrating example preliminary object models associated with an object in a physical environment in accordance with some implementations.

FIGS. 7A-7C are block diagrams illustrating example preliminary object models associated with an object in a physical environment in accordance with some implementations.

FIG. 8 is a system flow diagram of an example generation of a 3D model of an object based on images and tracked positions of the device during acquisition of the images according to some implementations.

FIG. 9 is a system flow diagram of an example generation of a live preview of a 3D model of an object based on images and tracked positions of the device during acquisition of the images according to some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

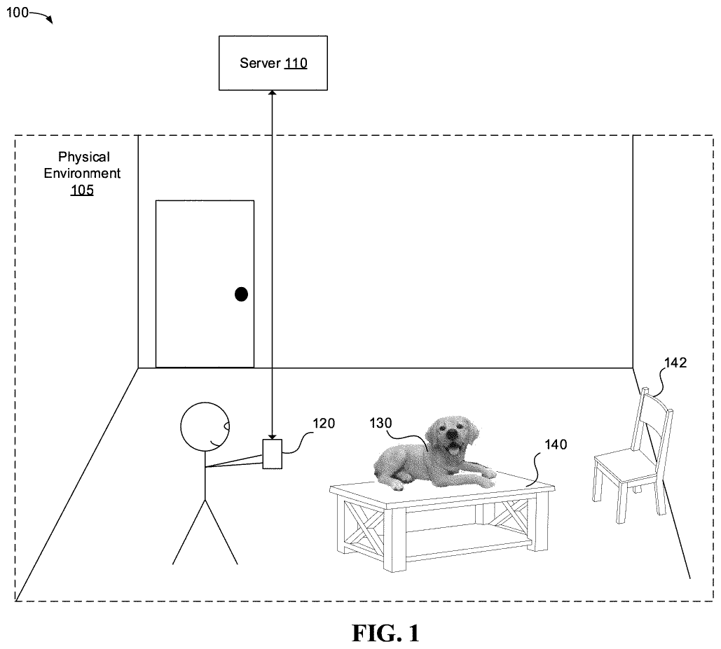

FIG. 1 is a block diagram of an example operating environment 100 in accordance with some implementations. In this example, the example operating environment 100 illustrates an example physical environment 105 that includes object 130 (e.g., a statue of a dog), table 140, chair 142. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a server 110 and a device 120. In an exemplary implementation, the operating environment 100 does not include a server 110, and the methods described herein are performed on the device 120.

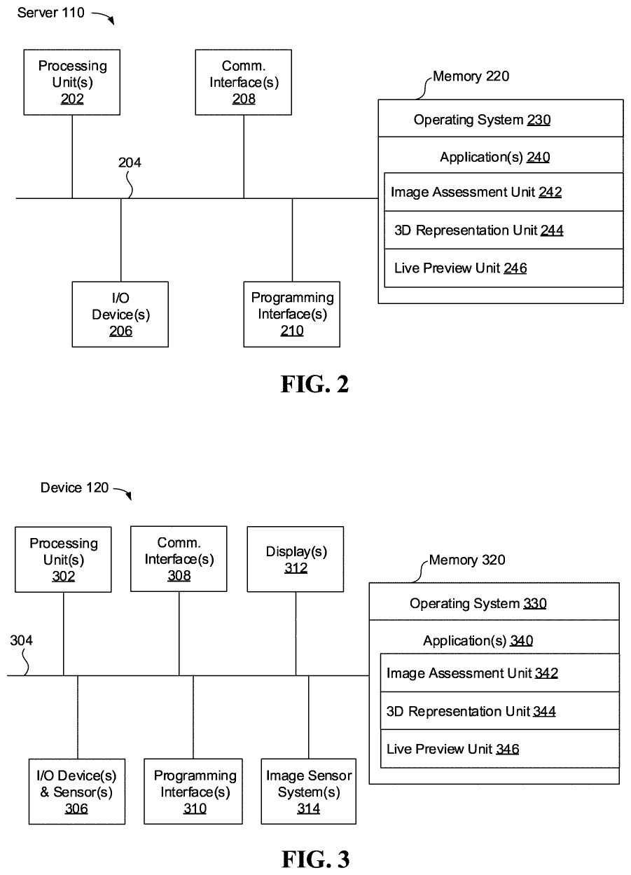

In some implementations, the server 110 is configured to manage and coordinate an experience for the user. In some implementations, the server 110 includes a suitable combination of software, firmware, and/or hardware. The server 110 is described in greater detail below with respect to FIG. 2. In some implementations, the server 110 is a computing device that is local or remote relative to the physical environment 105. In one example, the server 110 is a local server located within the physical environment 105. In another example, the server 110 is a remote server located outside of the physical environment 105 (e.g., a cloud server, central server, etc.). In some implementations, the server 110 is communicatively coupled with the device 120 via one or more wired or wireless communication channels (e.g., BLUETOOTH, IEEE 802.11x, IEEE 802.16x, IEEE 802.3x, etc.).

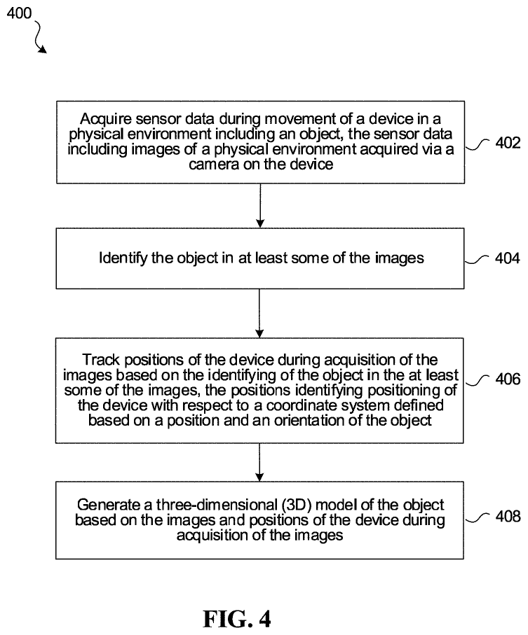

In some implementations, the device 120 is configured to present an environment to the user. In some implementations, the device 120 includes a suitable combination of software, firmware, and/or hardware. The device 120 is described in greater detail below with respect to FIG. 3. In some implementations, the functionalities of the server 110 are provided by and/or combined with the device 120.

In some implementations, the device 120 is a handheld electronic device (e.g., a smartphone or a tablet) configured to present content to the user. In some implementations, the user 102 wears the device 120 on his/her head. As such, the device 120 may include one or more displays provided to display content. For example, the device 120 may enclose the field-of-view of the user 102. In some implementations, the device 120 is replaced with a chamber, enclosure, or room configured to present content in which the user 102 does not wear or hold the device 120.

FIG. 2 is a block diagram of an example of the server 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the server 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 includes a non-transitory computer readable storage medium. In some implementations, the memory 220 or the non-transitory computer readable storage medium of the memory 220 stores the following programs, modules and data structures, or a subset thereof including an optional operating system 230 and one or more applications 240.

The operating system 230 includes procedures for handling various basic system services and for performing hardware dependent tasks. In some implementations, the applications 240 are configured to manage and coordinate one or more experiences for one or more users (e.g., a single experience for one or more users, or multiple experiences for respective groups of one or more users).

The applications 240 include an image assessment unit 242, a 3D representation unit 244, and a live preview unit 246. The image assessment unit 242, the 3D representation unit 244, and the live preview unit 246 can be combined into a single application or unit or separated into one or more additional applications or units.

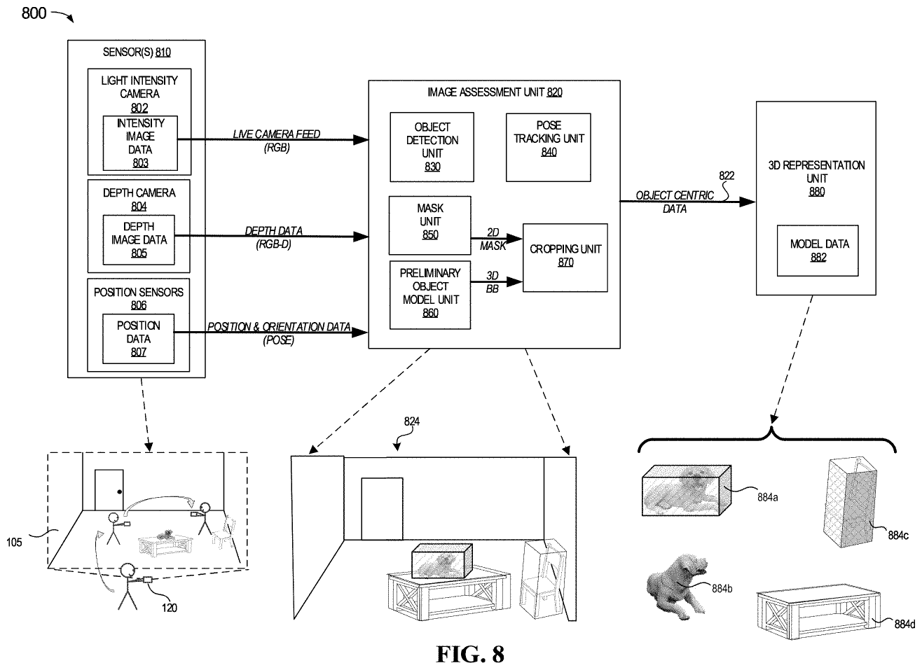

The image assessment unit 242 is configured with instructions executable by a processor to obtain sensor data (e.g., image data such as light intensity data, depth data, camera position information, etc.) and determine and select object centric data based on assessing the images with respect to the object based on images and tracked positions of a device during acquisition of the images using one or more of the techniques disclosed herein. For example, the image assessment unit 242 analyzes RGB images from a light intensity camera with a sparse depth map from a depth camera (e.g., time-of-flight sensor) and other sources of physical environment information (e.g., camera positioning information from a camera's SLAM system, VIO, or the like) to select a subset of sensor information for 3D reconstruction. In some implementations, the image assessment unit 242 includes separate units, such as an object detection unit, a pose tracking unit, a mask unit, a preliminary object model unit, and a cropping unit 3D as further discussed herein with reference to FIG. 8.

The 3D representation unit 244 is configured with instructions executable by a processor to obtain the object centric data from the image assessment unit 242 and generate a 3D model using one or more techniques disclosed herein. For example, the 3D representation unit 244 obtains the image assessment unit 242 from the image assessment unit 242, obtains segmentation data (e.g., RGB-S data), other sources of physical environment information (e.g., camera positioning information), and generates a 3D model (e.g., a 3D mesh representation, a 3D point cloud with associated semantic labels, or the like).

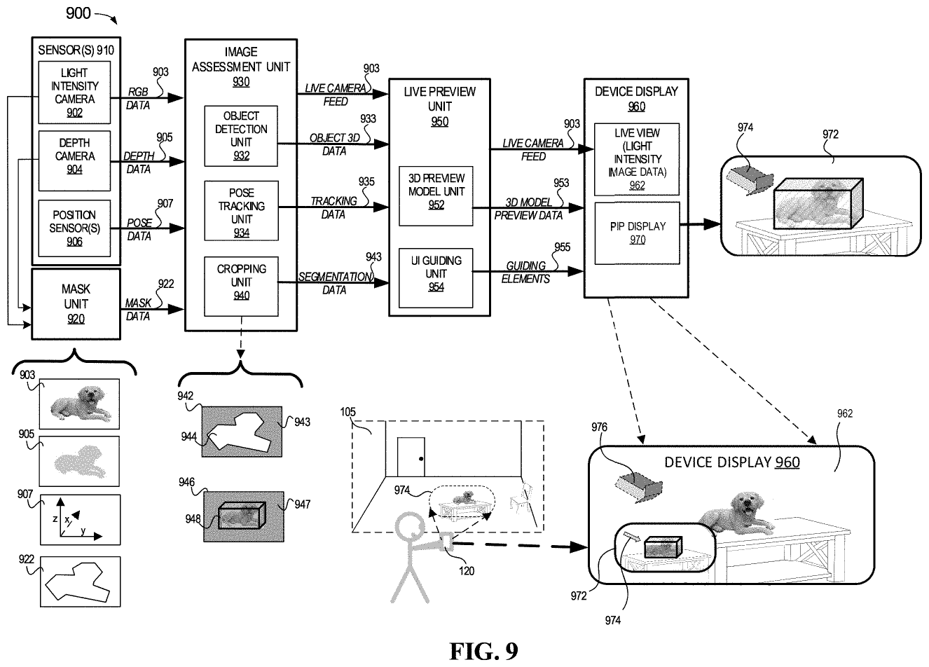

The live preview unit 246 is configured with instructions executable by a processor to generate and display a live preview of a preliminary 3D object model based on based on images and positions of a device during acquisition of the images of an object in a physical environment using one or more of the techniques disclosed herein. The preliminary 3D object model is then overlaid onto the live camera feed for a picture-in-picture display on a device. For example, the live preview unit 246 obtains a sequence of light intensity images from a light intensity camera (e.g., a live camera feed), tracking data (e.g., camera positioning information from a camera's simultaneous localization and mapping (SLAM) system) generated from a pose tracking unit (e.g., from the image assessment unit 242), segmentation data generated from a cropping unit (e.g., from the image assessment unit 242) to output a preliminary 3D object model that is iteratively updated with the sequence of light intensity images. In some implementations, the live preview unit 246 is further configured with instructions executable by a processor to generate user interface guiding elements to guide a user to acquire additional images at different perspective views. The guiding elements can be extended reality images that are overlaid in the live preview picture-in-picture view, or in the live camera feed. The guiding elements can guide the user to where to stand to acquire the additional images. In some implementations, the guiding elements can provide feedback to users to guide the user to acquire images with higher image quality. For example, if the camera is determined to be moving too fast, a guiding element could indicate that the camera is moving too quickly to the user as particular symbol, via text, or both. Additionally, a guiding element could indicate that the lighting is too dark, additional angles are needed, etc. In some implementations, the live preview unit 246 includes separate units, such as a 3D preview model unit and a user interface guiding unit to generate the guiding elements as further discussed herein with reference to FIG. 9.

Although these elements are shown as residing on a single device (e.g., the server 110), it should be understood that in other implementations, any combination of the elements may be located in separate computing devices. Moreover, FIG. 2 is intended more as functional description of the various features which are present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 120, and/or the like type interface), one or more programming (e.g., I/O) interfaces 310, one or more AR/VR displays 312, one or more interior and/or exterior facing image sensor systems 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 312 are configured to present the experience to the user. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. For example, the device 120 includes a single display. In another example, the device 120 includes an display for each eye of the user.

In some implementations, the one or more image sensor systems 314 are configured to obtain image data that corresponds to at least a portion of the physical environment 105. For example, the one or more image sensor systems 314 include one or more RGB cameras (e.g., with a complimentary metal-oxide-semiconductor (CMOS) image sensor or a charge-coupled device (CCD) image sensor), monochrome cameras, IR cameras, event-based cameras, and/or the like. In various implementations, the one or more image sensor systems 314 further include illumination sources that emit light, such as a flash. In various implementations, the one or more image sensor systems 314 further include an on-camera image signal processor (ISP) configured to execute a plurality of processing operations on the image data including at least a portion of the processes and techniques described herein.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 includes a non-transitory computer readable storage medium. In some implementations, the memory 320 or the non-transitory computer readable storage medium of the memory 320 stores the following programs, modules and data structures, or a subset thereof including an optional operating system 330 and one or more applications 340.

The operating system 330 includes procedures for handling various basic system services and for performing hardware dependent tasks. In some implementations, the applications 340 are configured to manage and coordinate one or more experiences for one or more users (e.g., a single experience for one or more users, or multiple experiences for respective groups of one or more users).

The applications 340 an image assessment unit 342, a 3D representation unit 344, and a live preview unit 346. The image assessment unit 342, the 3D representation unit 344, and the live preview unit 346 can be combined into a single application or unit or separated into one or more additional applications or units.

The image assessment unit 342 is configured with instructions executable by a processor to obtain sensor data (e.g., image data such as light intensity data, depth data, camera position information, etc.) and determine and select object centric data based on assessing the images with respect to the object based on images and tracked positions of a device during acquisition of the images using one or more of the techniques disclosed herein. For example, the image assessment unit 342 analyzes RGB images from a light intensity camera with a sparse depth map from a depth camera (e.g., time-of-flight sensor) and other sources of physical environment information (e.g., camera positioning information from a camera's SLAM system, VIO, or the like) to select a subset of sensor information for 3D reconstruction. In some implementations, the image assessment unit 342 includes separate units, such as an object detection unit, a pose tracking unit, a mask unit, a preliminary object model unit, and a cropping unit 3D as further discussed herein with reference to FIG. 8.

The 3D representation unit 344 is configured with instructions executable by a processor to obtain the object centric data from the image assessment unit 342 and generate a 3D model using one or more techniques disclosed herein. For example, the 3D representation unit 344 obtains the image assessment unit 342 from the image assessment unit 342, obtains segmentation data (e.g., RGB-S data), other sources of physical environment information (e.g., camera positioning information), and generates a 3D model (e.g., a 3D mesh representation, a 3D point cloud with associated semantic labels, or the like).

The live preview unit 346 is configured with instructions executable by a processor to generate and display a live preview of a preliminary 3D object model based on based on images and positions of a device during acquisition of the images of an object in a physical environment using one or more of the techniques disclosed herein. The preliminary 3D object model is then overlaid onto the live camera feed for a picture-in-picture display on a device. For example, the live preview unit 346 obtains a sequence of light intensity images from a light intensity camera (e.g., a live camera feed), tracking data (e.g., camera positioning information from a camera's simultaneous localization and mapping (SLAM) system) generated from a pose tracking unit (e.g., from the image assessment unit 342), segmentation data generated from a cropping unit (e.g., from the image assessment unit 342) to output a preliminary 3D object model that is iteratively updated with the sequence of light intensity images. In some implementations, the live preview unit 346 is further configured with instructions executable by a processor to generate user interface guiding elements to guide a user to acquire additional images at different perspective views. The guiding elements can be extended reality images that are overlaid in the live preview picture-in-picture view, or in the live camera feed. The guiding elements can guide the user to where to stand to acquire the additional images. The guiding elements can guide the user to where to stand to acquire the additional images. In some implementations, the guiding elements can provide feedback to users to guide the user to acuire images with higher image quality. For example, if the camera is determined to be moving too fast, a guiding element could indicate that the camera is moving too quickly to the user as particular symbol, via text, or both. Additionally, a guiding element could indicate that the lighting is too dark, additional angles are needed, etc. In some implementations, the live preview unit 346 includes separate units, such as a 3D preview model unit and a user interface guiding unit to generate the guiding elements as further discussed herein with reference to FIG. 9.

Although these elements are shown as residing on a single device (e.g., the device 120), it should be understood that in other implementations, any combination of the elements may be located in separate computing devices. Moreover, FIG. 3 is intended more as functional description of the various features which are present in a particular implementation as opposed to a structural schematic of the implementations described herein. As recognized by those of ordinary skill in the art, items shown separately could be combined and some items could be separated. For example, some functional modules (e.g., applications 340) shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

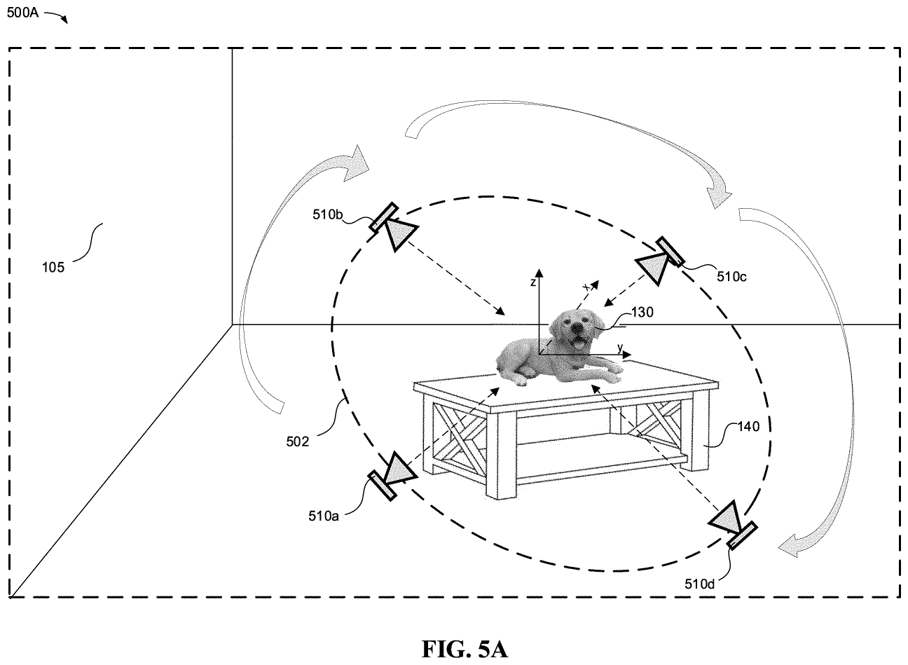

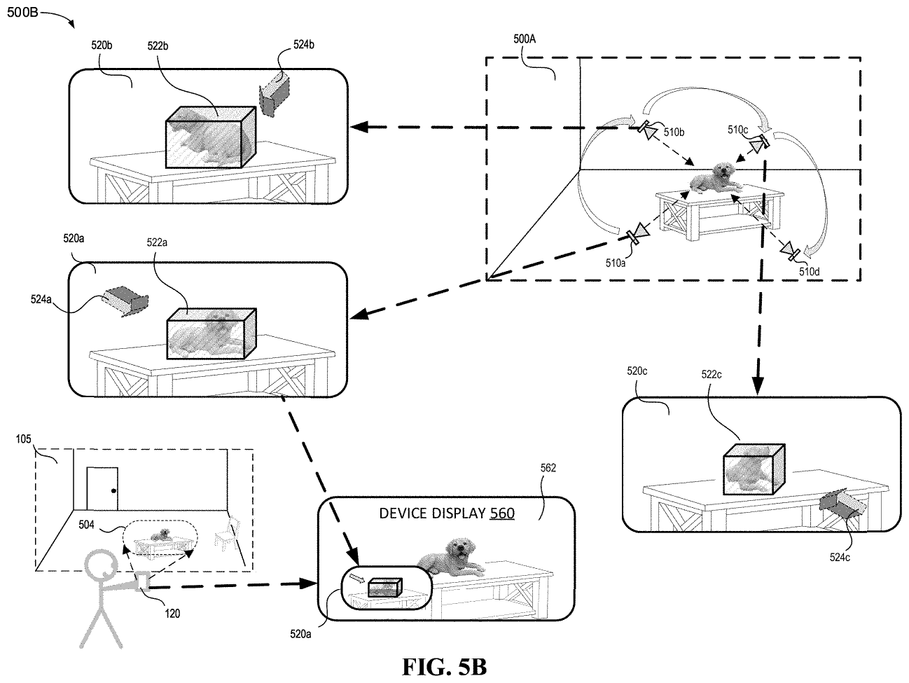

FIG. 4 is a flowchart representation of an exemplary method 400 that generates a 3D model of an object based on images and tracked positions of a device during acquisition of the images in accordance with some implementations. In some implementations, the method 400 is performed by a device (e.g., server 110 or device 120 of FIGS. 1-3), such as a mobile device, desktop, laptop, or server device. The method 400 can be performed on a device (e.g., device 120 of FIGS. 1 and 3) that has a screen for displaying images and/or a screen for viewing stereoscopic images such as a head-mounted display (HMD). In some implementations, the method 400 is performed by processing logic, including hardware, firmware, software, or a combination thereof. In some implementations, the method 400 is performed by a processor executing code stored in a non-transitory computer-readable medium (e.g., a memory). The 3D model creation process of method 400 is illustrated with reference to FIGS. 5-9.

At block 402, the method 400 acquires sensor data during movement of the device in a physical environment including an object, where the sensor data includes images of the physical environment acquired via a camera on the device (e.g., image sensor systems 314 of the device 120). For example, a user moves a device (e.g., a mobile device) around an object (e.g., a statue on top of a table such as object 130) in a physical environment to acquire images of the object from different sides. In some implementations, the sensor data may include depth data and motion sensor data. In some implementations, during movement of the device, a user interface may display the acquired environment that includes the object and provide a user interface element. For example, a user interface element (e.g., an extended reality image, such as a 3D arrow overlaid on a live video stream) can show a user additional angles and/or perspectives to acquire the object. In some implementations, the user interface can display a preliminary 3D model of the object (e.g., a 3D mesh, 3D bounding box, etc.). For example, a picture-in-picture display of another window can display to the user a 3D model reconstruction in a live preview screen as the user is capturing live video and as the live video is streaming on the main viewing screen.

The sensor data can include depth data. The depth data can include pixel depth values from a viewpoint and sensor position and orientation data. In some implementations, the depth data is obtained using one or more depth cameras. For example, the one or more depth cameras can acquire depth based on structured light (SL), passive stereo (PS), active stereo (AS), time-of-flight (ToF), and the like. Various techniques may be applied to acquire depth image data to assign each portion (e.g., at a pixel level) of the image. For example, voxel data (e.g., a raster graphic on a 3D grid, with the values of length, width, and depth) may also contain multiple scalar values such as opacity, color, and density. In some implementations, depth data is obtained from sensors or 3D models of the content of an image. Some or all of the content of an image can be based on a real environment, for example, depicting the physical environment 105 around the device 120. Image sensors may acquire images of the physical environment 105 for inclusion in the image and depth information about the physical environment 105. In some implementations, a depth sensor on the device 120 determines depth values for voxels that are determined based on images acquired by an image sensor on the device 120.

At block 404, the method 400 identifies the object in at least some of the images. For example, an image assessment unit (e.g., image assessment unit 242 of FIG. 2, and/or image assessment unit 342 of FIG. 3) assesses the sensor data to identify an object (e.g., object 130 of FIG. 1). In some implementations, identifying the object may involve identifying the object using a preliminary object model based on information from multiple images and depth information. Identifying the object using a preliminary object model may involve masking by creating a 3D bounding box corresponding to the object. Additionally, or alternatively, a two-dimensional (2D) mask corresponding to the object can also be created. During image acquisition, the 3D bounding box is adjusted to fit the object better to define the object of interest and separate from the background. In some implementations, object identification may be based on cropping/resizing the preliminary object model and the 3D keypoints associated with the preliminary object model. For example, using a 3D bounding box constraint to remove background pixels located outside of the 3D bounding box, and/or using a 2D mask constraint to remove background pixels located outside of a 2D mask associated with the object. The masking (e.g., cropping/resizing the preliminary object model) can occur during scanning (e.g., during image acquisition) to detect the object in a first stage and then when doing the image scanning, those masks (e.g., 3D bounding box constraint, 2D mask, etc.) are used to separate out the object by removing background pixels. In some implementations, the masking can use a coverage algorithm and go around the object and compute on the fly positions during image acquisition.

In some implementations, object identification can involve densification of a sparse 3D depth cloud. For example, creating a dense 3D depth cloud from sparse data sets using a densification algorithm. Additionally, or alternatively, in some implementations, object identification can involve keypoint interpolation and/or exclusion of keypoints close to depth edges. For example, using a keypoint object algorithm, keypoints of an object are identified (e.g., semantic labeling of an RGB image via a neural network) and additional keypoints (e.g., additional pixels associated with the object) can be interpolated (e.g., added) to the preliminary object model, or excluded (e.g., removed) from the preliminary object model.

At block 406, the method 400 tracks positions of the device during acquisition of the images based on the identifying of the object in the at least some of the images, the positions identifying positioning and/or orientation (e.g., pose information) of the device with respect to a coordinate system defined based on a position and an orientation of the object. In an exemplary implementation, tracking positions of the device during acquisition of the images based on the identifying of the object tracks the object by updating an object-centric pose of the device, e.g., where the camera is relative to the object in object-based coordinates when each of the images is acquired. In some implementations, the tracking can use a pose graph defined in the object-based coordinates (e.g., a historical record made of the relative RGB-D camera movement).

In some implementations, tracking may involve re-localizing when the object goes out of view or when an previously unseen portion of the object is acquired. For example, when an object is take away from the camera view and flipped over, the tracking may need to re-localize and further identify the object as the same object of interest and recalibrate the object centric coordinates to determine the flipped object is the same object of interest. In some implementations, the method may iteratively update both the camera's object centric pose and the preliminary object model.

In some implementations, the poses may be verified based on cropping/resizing the preliminary object model and its 3D keypoints, for example, using a 3D bounding box constraint to remove background image information and/or a 2D mask to remove background image pixels (e.g., similar to the process described above for the masking during the object identification phase). In some implementations, pose verification may further involve densification of a sparse depth cloud, keypoint interpolation, and/or exclusion of keypoints close to depth edges.

At block 408, the method 400 generates a 3D model of the object based on the images and positions of the device during acquisition of the images. For example, the 3D model may be a 3D mesh representation or a 3D point cloud. In some implementations, the 3D model data could be a 3D representation representing the surfaces in a 3D environment using a 3D point cloud with associated semantic labels. In some implementations, the 3D model data is a generated 3D reconstruction mesh using a meshing algorithm based on depth information detected in the physical environment that is integrated (e.g., fused) to recreate the object in the physical environment. A meshing algorithm (e.g., a dual marching cubes meshing algorithm, a poisson meshing algorithm, a tetrahedral meshing algorithm, or the like) can be used to generate a mesh representing a room (e.g., physical environment 105) and/or object(s) within a room (e.g., object 130, table 140, chair 142, etc.). In some implementations, for 3D reconstructions using a mesh, to efficiently reduce the amount of memory used in the reconstruction process, a voxel hashing approach is used in which 3D space is divided into voxel blocks, referenced by a hash table using their 3D positions as keys. The voxel blocks are only constructed around object surfaces, thus freeing up memory that would otherwise have been used to store empty space. The voxel hashing approach is also faster than competing approaches at that time, such as octree-based methods. In addition, it supports streaming of data between the GPU, where memory is often limited, and the CPU, where memory is more abundant.

In use, for the process 400, a user may desire to create a 3D reconstruction of a statue of a dog on a table (e.g., object 130), and the user may scan the object in a room with a device (e.g., a smartphone such as device 120) and the processes described herein would acquire sensor data (e.g., image data such as light intensity data, depth data, camera position information, etc.), assess the images with respect to object centric position tracking of the device with respect to the object, select a subset of the sensor data based on the assessment, and provide a 3D representation for the object as it is being scanned by the user. In some implementations, the 3D representation may be automatically displayed and updated on the user device overlaid during a live camera feed. In some implementations, the 3D representation may be provided after some type of user interaction after scanning the physical environment with more than one object identified. For example, the user may be shown options of identified objects, and the user may select or click on the particular object that the user wants included in the 3D representation, and the 3D representation would then be displayed with the selected object. Thus, as shown and discussed below with reference to FIG. 8, the image assessment unit (e.g., image assessment unit 242 of FIG. 2, and/or image assessment unit 342 of FIG. 3) identifies a subset of images for the object centric data that are to be utilized by a 3D representation unit (e.g., 3D representation unit 244 of FIG. 2, and/or 3D representation unit 344 of FIG. 3).

FIG. 5A is a block diagram of an example operating environment 500A illustrating example camera positions of a camera on a device (e.g., image sensor systems 314 of the device 120) with respect to an object (e.g., object 130) in a physical environment in accordance with some implementations. In this example, the example operating environment 500A illustrates an environment that includes a device 510, an object 130, and a table 140 from the physical environment 105 of FIG. 1. The device 510 is shown at four different camera views, device 510a-510d, each with a different field of view and perspective relative to the object 130, the target object (e.g., a statue of dog on a table). Although only four different camera views are illustrated on a pose graph path 502, there can be several more images acquired at any point on the pose graph path 502 as the user walks around the object 130 and scans the target object. Pose graph path 502 illustrates an example path the device is making around the object created by the user movement. For example, a pose graph is a historical record of the relative RGB-D camera movement with respect to the object. For example, keyframes can be assigned or positioned along the pose graph and a current camera position can be shown relative to the pose graph. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 500A includes a device 510.

FIG. 5B is a block diagram of an example operating environment 500B illustrating example user interfaces with respect to different camera positions of a camera on a device (e.g., image sensor systems 314 of the device 120) with respect to an object (e.g., object 130) in a physical environment as illustrated in example operating environment 500A. In this example, the example operating environment 500B illustrates user interfaces from the example operating environment 500A that includes a device 510, an object 130, and a table 140 from the physical environment 105 of FIG. 1. For example, when device 510A is in that position acquiring sensor data of the object 130 as illustrated, a user interface 562 is shown on a device display 560 with a picture-in-picture display 520a. The picture-in-picture display 520a includes a preliminary object model 522a (e.g., a 3D bounding box, a 3D rendering of the object such as a 3D mesh, a 3D reconstructed model, or the like) and a user interface guiding element 524a. The guiding element 524a is shown as a 3D extended reality image that is shown to the user to guide the user to move the device to that perspective to acquire additional sensor data. As the user and device moves, the guiding element would also move to continuously guide the user where to acquire different perspectives of the object in order to properly generate a 3D reconstruction as desired (e.g., a high-quality rendering of the object). The guiding element 524a is associated with the object 130 based on the object centric positioning data that is acquired as the device is moved around the object and with respect to the object as the user essentially creates the path of the pose graph 502. When device 510b is in that position acquiring sensor data of the object 130 as illustrated, a user interface 562 is shown on a device display 560 with a picture-in-picture display 520b. The picture-in-picture display 520b includes a preliminary object model 522b (e.g., a 3D bounding box, a 3D rendering of the object such as a 3D mesh, a 3D reconstructed model, or the like) and a user interface guiding element 524b, guiding the user to acquire additional images towards the position as illustrated by device 510c. When device 510c is in that position acquiring sensor data of the object 130 as illustrated, a user interface 562 is shown on a device display 560 with a picture-in-picture display 520c. The picture-in-picture display 520c includes a preliminary object model 522c (e.g., a 3D bounding box, a 3D rendering of the object such as a 3D mesh, a 3D reconstructed model, or the like) and a user interface guiding element 524c, guiding the user to acquire additional images towards the position as illustrated by device 510d. In some implementations, the guiding elements 524a-c follow a preset path around an object and with respect to a center of an object. Alternatively, the guiding elements 524a-c are iteratively updated as the system described herein (e.g., the image assessment unit) determines specific positions the device should acquire the image data, which may not require a full 360 degree coverage as illustrated in pose graph 502 of FIG. 5A. For example, the system may determine that only 200 degrees of coverage around the object is necessary to acquire enough sensor data to generate a 3D model of the object.

In some implementations, device position criteria is determined based on the geometry of the target object and the acquired data of the target object. For example, the system identifies the object 130 from the initial camera position of device 510a, and the device position criteria can determine or estimate (e.g., driven by the backend reconstruction requirements) the number of additional view and device positions that may be required to acquire sufficient image date to optimally reconstruct the target object completely and accurately to minimize the number of viewing positions or stations needed to make it easier for the user and less data for the local device (e.g., device 120 of FIGS. 1 and 3) to process and/or to send to a server (e.g., server 110 of FIGS. 1 and 2) to process.

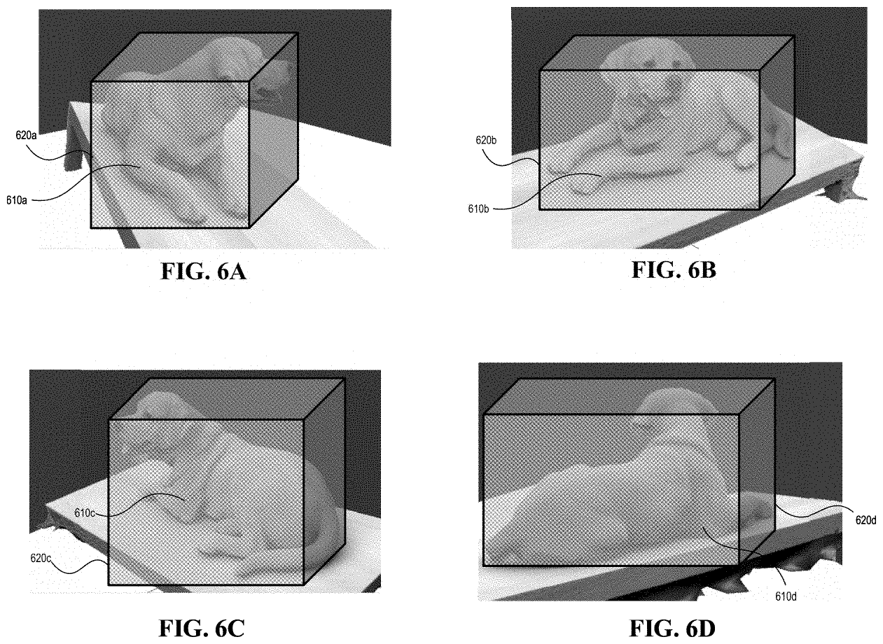

In some implementations, the device 510 may include one or more depth sensors (e.g., a structured light, a time-of-flight, or the like). As shown in FIGS. 5A and 5B, the device 510 is angled towards the object 130. As illustrated, a user is acquiring sensor data around the object 130 at different camera views. In some implementations, the user is constantly acquiring the image data as a live video, thus, as the user moves the device 510a to a position at device 510d along a path of the pose graph 502, a plurality of images from the sensor data can be acquired (e.g., a live video feed). Object centric position data may be determined by acquiring the devices position with respect to the object between image frames given the current motion of the camera and the distance of the camera to the object. Example views of devices 510a-510d, and their respective generated 3D bounding boxes (e.g., a preliminary object model) are further illustrated with reference to FIG. 6A-6D respectively.

FIGS. 6A-6D are block diagrams illustrating example views (acquired by the device 510 (e.g., device 510a-510d) in FIG. 5A in accordance with some implementations. In particular, FIG. 6A is an example camera view of device 510a with an object perspective view 610a and a preliminary object model 620a (e.g., a 3D bounding box, a 3D rendering of the object such as a 3D mesh, a 3D reconstructed model, or the like) that is generated in real time as the images are acquired of the object 130. FIG. 6B is an example camera view of device 510b with an object perspective view 610b and a preliminary object model 620b. FIG. 6C is an example camera view of device 510c with an object perspective view 610c and a preliminary object model 620c. FIG. 6D is an example camera view of device 510d with an object perspective view 610d and a preliminary object model 620d.

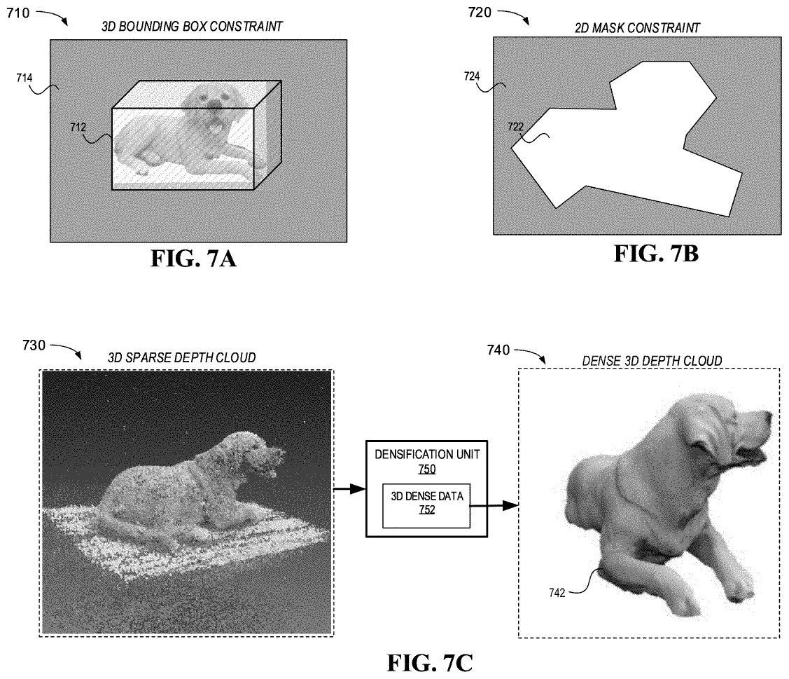

FIG. 7A is a block diagram 710 illustrating a preliminary object model (e.g., 3D bounding box 712) associated with an object (e.g., object 130) in a physical environment in accordance with some implementations. For example, a 3D bounding box constraint algorithm may be used to exclude image data region 714 outside of the 3D bounding box 712 in order to remove “background” data from the 3D model reconstruction. In other words, the 3D bounding box constraint limits the amount of sensor data that would be sent to a 3D representation unit (e.g., 3D representation unit 244 of FIG. 2 and/or 3D representation unit 344 of FIG. 3) to generate the 3D model of the object.

FIG. 7B is a block diagram 720 illustrating a preliminary object model (e.g., 2D mask 722) associated with an object (e.g., object 130) in a physical environment in accordance with some implementations. For example, a 2D mask constraint algorithm may be used to exclude image data region 724 outside of the 2D mask 722 in order to remove “background” data from the RGB images sent to the 3D model reconstruction unit. In other words, the 2D mask constraint limits the amount of sensor data that would be sent to a 3D representation unit (e.g., 3D representation unit 244 of FIG. 2 and/or 3D representation unit 344 of FIG. 3) to generate the 3D model of the object.

FIG. 7C is a block diagram of an example environment for densification of a 3D sparse depth cloud of an object. For example, 3D sparse depth cloud 730 of the object 130 is sent to a densification unit 750 that generates 3D dense data 752. The 3D dense data 752 may include the example dense 3D depth cloud 740. In some implementations, the densification unit 750 obtains depth data from a camera of a device (e.g., device 120) and can generate and send the 3D dense data 752 to image assessment unit (e.g., image assessment unit 242 of FIG. 2 and/or image assessment unit 342 of FIG. 3).

Alternatively, the image assessment unit can include the densification unit 750.

FIG. 8 is a system flow diagram of an example environment 800 in which a system can generate 3D model of an object based on images and positions of a device during acquisition of the images according to some implementations. In some implementations, the system flow of the example environment 800 is performed on a device (e.g., server 110 or device 120 of FIGS. 1-3), such as a mobile device, desktop, laptop, or server device. The system flow of the example environment 800 can be displayed on a device (e.g., device 120 of FIGS. 1 and 3) that has a screen for displaying images and/or a screen for viewing stereoscopic images such as a head-mounted display (HMD). In some implementations, the system flow of the example environment 800 is performed on processing logic, including hardware, firmware, software, or a combination thereof. In some implementations, the system flow of the example environment 800 is performed on a processor executing code stored in a non-transitory computer-readable medium (e.g., a memory).

The system flow of the example environment 800 acquires from sensors (e.g., sensors 810) light intensity image data 803 (e.g., live camera feed such as RGB from light intensity camera 802), depth image data 805 (e.g., depth image data such as RGB-D from depth camera 804), and other sources of physical environment information (e.g., camera positioning information 807 such as position and orientation data from position sensors 806) of a physical environment (e.g., the physical environment 105 of FIG. 1), assesses the images and determines and selects object centric data with respect to the object based on images and tracked positions of a device during acquisition of the images (e.g., the image assessment unit 820), and generates 3D model data 842 of the object from the object centric data (e.g., the 3D representation unit 880).

In an example implementation, the environment 800 includes an image composition pipeline that acquires or obtains data (e.g., image data from image source(s) such as sensors 810) for the physical environment. Example environment 800 is an example of acquiring image sensor data (e.g., light intensity data, depth data, and position information) for a plurality of image frames. The image source(s) may include a depth camera 804 that acquires depth data 805 of the physical environment, a light intensity camera 802 (e.g., RGB camera) that acquires light intensity image data 803 (e.g., a sequence of RGB image frames), and position sensors 806 to acquire positioning information. For the positioning information 807, some implementations include a visual inertial odometry (VIO) system to determine equivalent odometry information using sequential camera images (e.g., light intensity data 803) to estimate the distance traveled. Alternatively, some implementations of the present disclosure may include a SLAM system (e.g., position sensors 806). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the environment 800 includes an image assessment unit 820 that is configured with instructions executable by a processor to obtain sensor data (e.g., image data such as light intensity data, depth data, camera position information, etc.) and select object centric subset of sensor data (e.g., object centric data 822) using one or more of the techniques disclosed herein. In some implementations, image assessment unit 820 includes an object detection unit 830 that is configured with instructions executable by a processor to analyze the image information and identify objects within the image data. For example, the object detection unit 830 of the image assessment unit 820 (e.g., image assessment unit 242 of FIG. 2 and/or image assessment unit 342 of FIG. 3) analyzes RGB images from a light intensity camera 802 with a sparse depth map from a depth camera 804 (e.g., time-of-flight sensor) and other sources of physical environment information (e.g., camera positioning information 807 from a camera's SLAM system, VIO, or the like such as position sensors 806) to identify objects (e.g., furniture, appliances, statues, etc.) in the sequence of light intensity images. In some implementations, the object detection unit 830 uses machine learning for object identification. In some implementations, the machine learning model is a neural network (e.g., an artificial neural network), decision tree, support vector machine, Bayesian network, or the like. For example, the object detection unit 830 uses an object detection neural network unit to identify objects and/or an object classification neural network to classify each type of object.

In some implementations, image assessment unit 820 includes a pose tracking unit 840 that is configured with instructions executable by a processor to analyze the image information with respect to the positioning and orientation information (e.g., position data 807) of the device motion during image acquisition. For example, the pose tracking unit 840 of the image assessment unit 820 (e.g., image assessment unit 242 of FIG. 2 and/or image assessment unit 342 of FIG. 3) analyzes camera positioning information 807 from a camera's SLAM system, VIO, or the like (e.g., position sensors 806) to track the device location with respect to object (e.g., object centric data) in the sequence of light intensity images. In some implementations, the pose tracking unit 840 generates a pose graph (e.g. pose graph path 502 of FIG. 5A) as a historical record of the relative RGB-D camera movement (e.g., device 510a-510d) with respect to the object (e.g., object 130). For example, keyframes can be assigned or positioned along the pose graph and a current camera position can be shown relative to the pose graph.

In some implementations, image assessment unit 820 includes a mask unit 850 to generate a 2D mask, a preliminary object model unit 860 to generate a preliminary object model (e.g., a 3D bounding box, a 3D rendering of the object such as a 3D mesh, a 3D reconstructed model, or the like), and a cropping unit 870 for removing background information from the image data based on the 2D mask and the 3D bounding box information. For example, a 2D mask constraint algorithm may be used by the cropping unit 870 to exclude image data region (e.g., image data region 724) outside of the 2D mask (e.g., 2D mask 722) in order to remove “background” data from the RGB images sent to the 3D model reconstruction unit (e.g., 3D representation unit 880). In other words, the 2D mask constraint limits the amount of sensor data that would be sent to a 3D representation unit 880 (e.g., 3D representation unit 244 of FIG. 2 and/or 3D representation unit 344 of FIG. 3) to generate the 3D model of the target object (e.g., object 130). In some implementations, object identification may be based on cropping/resizing the preliminary object model and the 3D keypoints associated with the preliminary object model. For example, the cropping unit 870 can use a 3D bounding box constraint to remove background pixels located outside of the 3D bounding box generated by the preliminary object model unit 860 to remove background pixels located outside of the 3D bounding box associated with the object. The masking (e.g., cropping/resizing the preliminary object model) can occur during scanning (e.g., during image acquisition) to detect the object in a first stage and then when doing the image scanning, those masks (e.g., 3D bounding box constraint, 2D mask, etc.) are used to separate out the object by removing background pixels. In some implementations, the masking can use a coverage algorithm and go around the object and compute on the fly positions during image acquisition.

The image assessment unit 820 selects a subset of the sensor data from sensors 810 (e.g., selecting object centric data) based on the analysis from the subunits (e.g., object detection unit 830, pose tracking unit 840, mask unit 850, preliminary object model unit 860, and the cropping unit 870) assessing the images and determining and selecting the object centric data with respect to the object based on images and tracked positions of the device (e.g., device 120) during acquisition of the images. The image assessment unit 820 focuses on the image acquisition with respect to the camera pose that is object centric, e.g., defined in terms of an object-based coordinate system. Thus, the pose tracking unit 840 of the image acquisition system 820 tracks the object by updating the object-centric pose of the device, e.g., where the camera is relative to the object in object-based coordinates when each of the images is acquired.

Additionally, or alternatively, in some implementations, tracking may involve re-localizing when the object goes out of view or when an previously unseen portion of the object is acquired. For example, when an object is take away from the camera view and flipped over, the tracking may need to re-localize and further identify the object as the same object of interest and recalibrate the object centric coordinates to determine the flipped object is the same object of interest. In some implementations, the method may iteratively update both the camera's object centric pose and the preliminary object model.

Additionally, or alternatively, in some implementations, image information may be selected to ensure that the images include the object or particular object features (e.g., an edge of an object, a closest point of the object to the camera, a recognized mark such as a brand name and/or symbol, or the like). For example, the image assessment unit 820 may analyze the image information, determine a particular feature of an object, and limit the subset of images that include those features in order to ensure that only images in the subset that are included in the subset data (e.g., object centric data 822) are sent to the 3D reconstruction unit 880. Thus, limiting the data set in the object centric data 822 to only images that include the particular object. In some implementations, a picture-in-picture preview may be displayed during the movement of the device based on the selected subset of the images, as illustrated with reference to FIG. 9.

In an example implementation, the environment 800 further includes a 3D representation unit 880 that is configured with instructions executable by a processor to obtain the object centric subset of sensor data (e.g., object centric data 822) from the image assessment unit 820 and generate a 3D model data 882 using one or more techniques. For example, the 3D representation unit 880 (e.g., 3D representation unit 244 of FIG. 2 and/or 3D representation unit 344 of FIG. 3) generates 3D models 884a-884d for each detected object (e.g., a 3D bounding box 844a for object 130, a 3D reconstruction model 884b, a 3D bounding box 844b for table 140, and a 3D bounding box 844c for chair 142).

The 3D model data could be 3D representations 844a-844d representing the surfaces in a 3D environment using a 3D point cloud with associated semantic labels. The 3D representations 844a, 884c, and 844d are illustrated as 3D bounding boxes for the object 130, table 140, and chair 142, respectively. In some implementations, the 3D model data 842 is a 3D reconstruction mesh that is generated using a meshing algorithm based on depth information detected in the physical environment that is integrated (e.g., fused) to recreate the physical environment. A meshing algorithm (e.g., a dual marching cubes meshing algorithm, a poisson meshing algorithm, a tetrahedral meshing algorithm, or the like) can be used to generate a mesh representing a room (e.g., physical environment 105) and/or object(s) within a room (e.g., object 130, table 140, chair 142, etc.). In some implementations, for 3D reconstructions using a mesh, to efficiently reduce the amount of memory used in the reconstruction process, a voxel hashing approach is used in which 3D space is divided into voxel blocks, referenced by a hash table using their 3D positions as keys. The voxel blocks are only constructed around object surfaces, thus freeing up memory that would otherwise have been used to store empty space. The voxel hashing approach is also faster than competing approaches at that time, such as octree-based methods. In addition, it supports streaming of data between the GPU, where memory is often limited, and the CPU, where memory is more abundant.

In some implementations, the generated 3D model data 882 of the object is determined based on refined images, where the refined images are determined based on at least one of 3D keypoint interpolation, densification of 3D sparse point clouds associated with the images, a 2D mask corresponding to the object to remove background image pixels of the images, and/or a 3D bounding box constraint corresponding to the object to remove background image pixels of the images. In some implementations, the 3D keypoint interpolation, the densification of the 3D sparse point clouds, the 2D mask, and the 3D bounding box constraint are based on the coordinate system (e.g., pose tracking data of the pose tracking unit 840) of the object (e.g., object centric data 822).

In some implementations, the 3D representation unit 880 includes an integration unit that is configured with instructions executable by a processor to obtain the subset of image data (e.g., light intensity data 803, depth data 805, etc.) and positioning information (e.g., camera pose information 807 from position sensors 806) and integrate (e.g., fuse) the subset of image data using one or more known techniques. For example, the image integration unit receives a subset of depth image data 805 (e.g., sparse depth data) and a subset of intensity image data 803 (e.g., RGB) from the image sources (e.g., light intensity camera 802 and depth camera 804), and integrates the subset of image data and generates 3D data. The 3D data can include a dense 3D point cloud (e.g., imperfect depth maps and camera poses for a plurality of image frames around the object) that is sent to the 3D representation unit 880. The 3D data can also be voxelized. In some implementations, the integration unit is within the image assessment unit 820, and the object centric data 822 is integrated by the integration unit before being processed by the 3D representation unit 880.

In some implementations, the 3D representation unit includes a semantic segmentation unit that is configured with instructions executable by a processor to obtain a subset the light intensity image data (e.g., light intensity data 803) and identify and segment wall structures (wall, doors, windows, etc.) and objects (e.g., person, table, teapot, chair, vase, etc.) using one or more known techniques. For example, the segmentation unit receives a subset of intensity image data 803 from the image sources (e.g., light intensity camera 802), and generates segmentation data (e.g., semantic segmentation data such as RGB-S data). In some implementations, a segmentation unit uses a machine learning model, where a semantic segmentation model may be configured to identify semantic labels for pixels or voxels of image data. In some implementations, the machine learning model is a neural network (e.g., an artificial neural network), decision tree, support vector machine, Bayesian network, or the like. In some implementations, the semantic segmentation unit is within the image assessment unit 820, and the object centric data 822 is semantically labeled by the semantic segmentation unit before being processed by the 3D representation unit 880.

FIG. 9 is a system flow diagram of an example environment 900 in which a system can generate and display a live preview of a 3D model of an object (e.g., a 3D point cloud, a 3D mesh reconstruction, a 3D bounding box associated with an object, etc.) based on images and positions of a device during acquisition of the images according to some implementations. In some implementations, the system flow of the example environment 900 is performed on a device (e.g., server 110 or device 120 of FIGS. 1-3), such as a mobile device, desktop, laptop, or server device. The system flow of the example environment 900 can be displayed on a device (e.g., device 120 of FIGS. 1 and 3) that has a screen for displaying images and/or a screen for viewing stereoscopic images such as a head-mounted display (HMD). In some implementations, the system flow of the example environment 900 is performed on processing logic, including hardware, firmware, software, or a combination thereof. In some implementations, the system flow of the example environment 900 is performed on a processor executing code stored in a non-transitory computer-readable medium (e.g., a memory).

The system flow of the example environment 900 acquires from sensors (e.g., sensors 910) light intensity image data 903 (e.g., live camera feed such as RGB from light intensity camera 902), depth image data 905 (e.g., depth image data such as RGB-D from depth camera 904), and other sources of physical environment information (e.g., camera positioning information 907 such as position and orientation data from position sensors 906) of a physical environment (e.g., the physical environment 105 of FIG. 1), assesses the images and determines and selects object centric data with respect to the object based on images and tracked positions of a device during acquisition of the images (e.g., the image assessment unit 930), generates 3D model preview data from the subset of object centric sensor data (e.g., live preview unit 950), and displays a live preview of the 3D model as it is being generated overlaid on a live camera view on a display of a device. In some implementations, the system flow of the example environment 900 includes generating and displaying guiding elements to aid the user in acquiring the images at particular positions to properly acquire the object (e.g., acquire additional images with higher image quality, different angles, etc.).

In an example implementation, the environment 900 includes an image composition pipeline that acquires or obtains data (e.g., image data from image source(s)) for the physical environment. Example environment 900 is an example of acquiring image sensor data (e.g., light intensity data, depth data, and position information) for a plurality of image frames. The image source(s) may include a depth camera 904 that acquires depth data 905 of the physical environment, a light intensity camera 902 (e.g., RGB camera) that acquires light intensity image data 903 (e.g., a sequence of RGB image frames), and position sensors to acquire positioning information. For the positioning information 907, some implementations include a visual inertial odometry (VIO) system to determine equivalent odometry information using sequential camera images (e.g., light intensity data 903) to estimate the distance traveled. Alternatively, some implementations of the present disclosure may include a SLAM system (e.g., position sensors 906). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the environment 900 includes an image assessment unit 930 that is configured with instructions executable by a processor to obtain sensor data (e.g., image data such as light intensity data, depth data, camera position information, etc.) and select object centric subset of sensor data (e.g., object centric data 922) using one or more of the techniques disclosed herein. In some implementations, image assessment unit 930 includes an object detection unit 930 that is configured with instructions executable by a processor to analyze the image information and identify objects within the image data. For example, the object detection unit 932 of the image assessment unit 930 (e.g., image assessment unit 242 of FIG. 2 and/or image assessment unit 342 of FIG. 3) analyzes RGB images from a light intensity camera 902 with a sparse depth map from a depth camera 904 (e.g., time-of-flight sensor) and other sources of physical environment information (e.g., camera positioning information 907 from a camera's SLAM system, VIO, or the like such as position sensors 906) to identify objects (e.g., furniture, appliances, statues, etc.) in the sequence of light intensity images. In some implementations, the object detection unit 932 uses machine learning for object identification. In some implementations, the machine learning model is a neural network (e.g., an artificial neural network), decision tree, support vector machine, Bayesian network, or the like. For example, the object detection unit 932 uses an object detection neural network unit to identify objects and/or an object classification neural network to classify each type of object. In some implementations, the object detection unit 932 generates a 3D bounding box (e.g., 3D bounding box 948) associated with the identified object.

In some implementations, image assessment unit 930 includes a pose tracking unit 934 that is configured with instructions executable by a processor to analyze the image information with respect to the positioning and orientation information (e.g., position data 907) of the device motion during image acquisition. For example, the pose tracking unit 934 of the image assessment unit 930 (e.g., image assessment unit 242 of FIG. 2 and/or image assessment unit 342 of FIG. 3) analyzes camera positioning information 907 from a camera's SLAM system, VIO, or the like (e.g., position sensors 906) to track the device location with respect to object (e.g., object centric data) in the sequence of light intensity images. In some implementations, the pose tracking unit 934 generates a pose graph (e.g. pose graph path 502 of FIG. 5A) as a historical record of the relative RGB-D camera movement (e.g., device 510a-510d) with respect to the object (e.g., object 130). For example, keyframes can be assigned or positioned along the pose graph and a current camera position can be shown relative to the pose graph.

In some implementations, a mask unit 920 generates a 2D mask based on received image data (e.g., RGB data 903 and/or depth data 905) and sends the 2D mask data 922 to the image assessment unit 930. In some implementations, the image assessment unit 930 includes the mask unit 920 to generate the 2D mask data (e.g., as discussed herein for image assessment unit 820). The image assessment unit 930 further includes the object detection unit 932 to generate a 3D bounding box associated with the identified object, and a cropping unit 940 for removing background information from the image data based on the 2D mask and the 3D bounding box information to generate segmentation data 943. For example, as illustrated by 2D mask data 942, a 2D mask constraint algorithm may be used by the cropping unit 940 to exclude image data region (e.g., image data region 943) outside of the 2D mask (e.g., 2D mask 944) in order to remove “background” data from the RGB images sent to a 3D model reconstruction unit (e.g., 3D preview model unit 952). In other words, the 2D mask constraint limits the amount of sensor data that would be sent to a 3D representation unit (e.g., 3D representation unit 244 of FIG. 2 and/or 3D representation unit 344 of FIG. 3) to generate a preview 3D model of the target object (e.g., object 130). In some implementations, object identification may be based on cropping/resizing the preliminary object model and the 3D keypoints associated with the preliminary object model. For example, as illustrated by 3D bounding box data 946, the cropping unit 940 can use a 3D bounding box constraint to remove background pixels (e.g., image data region 947) located outside of the 3D bounding box (e.g., 3D bounding box 948) generated by the object detection unit 932 (e.g., preliminary object model unit 860 of FIG. 8) to remove background pixels located outside of the 3D bounding box 948 associated with the object (e.g., object 130). The masking (e.g., cropping/resizing the preliminary object model) can occur during scanning (e.g., during image acquisition) to detect the object in a first stage and then when doing the image scanning, those masks (e.g., 3D bounding box constraint, 2D mask, etc.) are used to separate out the object by removing background pixels. In some implementations, the masking can use a coverage algorithm and go around the object and compute on the fly positions during image acquisition.

The image assessment unit 930 selects a subset of the sensor data from sensors 910 (e.g., selecting object centric data) based on the analysis from the subunits (e.g., object detection unit 932, pose tracking unit 934, and the cropping unit 940) assessing the images and determining and selecting the object centric data (e.g., object 3D data 933, tracking data 935, and segmentation data 943) with respect to the object based on images and tracked positions of the device (e.g., device 120) during acquisition of the images. The image assessment unit 930 focuses on the image acquisition with respect to the camera pose that is object centric, e.g., defined in terms of an object-based coordinate system. Thus, the pose tracking unit 934 of the image assessment unit 930 tracks the object by updating the object-centric pose of the device, e.g., where the camera is relative to the object in object-based coordinates when each of the images is acquired.

Additionally, or alternatively, in some implementations, tracking may involve re-localizing when the object goes out of view or when an previously unseen portion of the object is acquired. For example, when an object is take away from the camera view and flipped over, the tracking may need to re-localize and further identify the object as the same object of interest and recalibrate the object centric coordinates to determine the flipped object is the same object of interest. In some implementations, the method may iteratively update both the camera's object centric pose and the preliminary object model.

Additionally, or alternatively, in some implementations, image information may be selected to ensure that the images include the object or particular object features (e.g., an edge of an object, a closest point of the object to the camera, a recognized mark such as a brand name and/or symbol, or the like). For example, the image assessment unit 930 may analyze the image information, determine a particular feature of an object, and limit the subset of images that include those features in order to ensure that only images in the subset that are included in the subset data (e.g., object centric data 922) are sent to the 3D reconstruction unit 980. Thus, limiting the data set in the object centric data 922 to only images that include the particular object. In some implementations, a picture-in-picture preview (e.g., PIP display 970) may be displayed during the movement of the device based on the selected subset of object centric image data.

In an example implementation, the environment 900 further includes a live preview unit 950 that is configured with instructions executable by a processor to obtain the object centric data (e.g., object 3D data 933, tracking data 935, and segmentation data 943) and the live camera feed 903 from the image assessment unit 930. The live preview unit 950 includes a 3D preview model unit 952 that is configured with instructions executable by a processor to obtain the object centric data (e.g., object 3D data 933, tracking data 935, and segmentation data 943) and generate 3D model preview data 953 using one or more techniques. For example, the 3D preview model unit 952 generates 3D model previews for each detected object (e.g., object 130, table 140, and chair 142).

The 3D model preview data 953 could be 3D representations representing the surfaces in a 3D environment using a 3D point cloud with associated semantic labels. The 3D representations could be similar to 3D representations 884a, 884c, and 844d of FIG. 8 illustrated as 3D bounding boxes for the object 130, table 140, and chair 142, respectively. In some implementations, the 3D model preview data is a 3D reconstruction mesh that is generated using a meshing algorithm based on depth information detected in the physical environment that is integrated (e.g., fused) to recreate the physical environment. A meshing algorithm (e.g., a dual marching cubes meshing algorithm, a poisson meshing algorithm, a tetrahedral meshing algorithm, or the like) can be used to generate a mesh representing a room (e.g., physical environment 105) and/or object(s) within a room (e.g., object 130, table 140, chair 142, etc.).

Additionally, the live preview unit 950 includes a user interface guiding unit 954 that obtains the object centric data (e.g., object 3D data 933, tracking data 935, and segmentation data 943) and the live camera feed 903 from the image assessment unit 930 and generates the user interface guiding elements 955 (e.g., guiding elements 524a-c as illustrated in FIG. 5). For example, the guiding element 974 in the picture-in-picture display 972 and guiding element 976 in the device display 960 are illustrated as exemplary implementation. The guiding elements data 955 can be 3D extended reality images, or the like, that are displayed to a user to guide the user to move the device to that perspective to acquire additional sensor data. As the user and device moves, the guiding element would also move to continuously guide the user where to acquire different perspectives of the object in order to properly generate a 3D reconstruction as desired (e.g., a high-quality rendering of the object). Additionally, or alternatively, the guiding elements can guide the guiding elements can provide feedback to users to guide the user to acquire images with higher image quality. For example, if the camera is determined to be moving too fast, a guiding element could indicate that the camera is moving too quickly to the user as particular symbol, via text, or both. Additionally, a guiding element could indicate that the lighting is too dark, additional angles are needed, etc. The guiding elements are associated with the target object based on the object centric positioning data that is acquired as the device is moved around the object and with respect to the object.

In an example implementation, the environment 900 further includes a device display 960 (e.g., display 312 of FIG. 3) that is configured to obtain guiding element data 955, a live camera feed 903, and the 3D model preview data 953 from the live preview unit 950, and generate a live view and a picture-in-picture (PIP) display of the 3D model(s) as the 3D model(s) are being generated using one or more techniques. For example, the device display 960 can display a live view 962 (e.g., light intensity image data 903), and a PIP display module 970 can generate and display a PIP preview 972. The PIP preview 972 can be iteratively updated as the 3D preview model unit 952 continuously updates the 3D preview model as the subset image data is acquired from the image assessment unit 930. Additionally, the PIP display module 970 can obtain the user interface guiding element data 955 from the user interface guiding unit 954 and display the user interface guiding element 974 in the PIP preview 972. For example, the PIP preview 972 illustrates the guiding element 974 (e.g., a 3D arrow pointing to the area of the object to position the device to acquire additional image data). As a user obtains images of an object, the system determines which portions of the object were efficiently obtained and continuously moves the guiding element 974 around object until sufficient image data is acquired. The user interface guiding elements aid the user in obtaining the images needed to be acquired for generating a 3D model of the object. Additionally, or alternatively, the guiding element data 955 can generate guiding elements over laid on the live camera feed (e.g. live view 962). For example, guiding element 976 is illustrated on the live view of the device display 960, guiding the user to move the device to the backside of the object (e.g., a rear view of the object 130—the statue of a dog).

In some implementations, the image composition pipeline may include virtual content (e.g., a virtual box placed on the table 140 in FIG. 1) that is generated for an extended reality (XR) environment. In some implementations, the operating systems 230, 330 includes built in XR functionality, for example, including a XR environment application or viewer that is configured to be called from the one or more applications 240, 340 to display a XR environment within a user interface. For example, the systems described herein may include a XR unit that is configured with instructions executable by a processor to provide a XR environment that includes depictions of a physical environment including real physical objects and virtual content. A XR unit can generate virtual depth data (e.g., depth images of virtual content) and virtual intensity data (e.g., light intensity images (e.g., RGB) of the virtual content). For example, one of the applications 240 for the server 110 or applications 340 for the device 120 could include a XR unit that is configured with instructions executable by a processor to provide a XR environment that includes depictions of a physical environment including real objects or virtual objects. The virtual objects may be positioned based on the detection, tracking, and representing of objects in 3D space relative to one another based on stored 3D models of the real objects and the virtual objects, for example, using one or more of the techniques disclosed herein.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device having a processor:
acquiring sensor data during movement of the device in a physical environment comprising an object, the sensor data comprising images of the physical environment acquired via a camera on the device;
identifying the object in at least some of the images;
tracking positions of the device during acquisition of the images based on the identifying of the object in the at least some of the images, the positions identifying positioning of the device with respect to a coordinate system defined based on a position and an orientation of the object; and
generating a three-dimensional (3D) model of the object based on the images and positions of the device during acquisition of the images.

2. The method of claim 1, wherein acquiring the sensor data during the movement of the device comprises acquiring images from different perspectives of the object as the device is moved around the object.

3. The method of claim 1, wherein the device comprises a user interface, and wherein the method further comprises, during the movement of the device, displaying the acquired images of the physical environment including the object within the user interface.

4. The method of claim 1, wherein identifying the object comprises generating a preliminary object model based on depth information from the images of the physical environment, the preliminary object model including 3D keypoints corresponding to the object.

5. The method of claim 4, wherein the preliminary object model is a 3D bounding box, wherein generating a 3D bounding box comprises:
obtaining a 3D representation of the physical environment that was generated based on the depth data;
determining a ground plane corresponding to the object in the physical environment based on the 3D representation; and
generating the 3D bounding box corresponding to the object in the physical environment based on the ground plane and the 3D representation.

6. The method of claim 5, wherein identifying the object further comprises adjusting the preliminary object model based on the 3D keypoints corresponding to the object.

7. The method of claim 6, wherein adjusting the preliminary object model is based on a 3D bounding box constraint used to remove background information included in the 3D bounding box to generate an updated 3D bounding box.

8. The method of claim 4, wherein the depth information includes a sparse 3D point cloud, wherein identifying the object further comprises densification of the sparse 3D point cloud based on the 3D keypoints corresponding to the object.

9. The method of claim 1, wherein identifying the object further comprises keypoint interpolation based on 3D keypoints corresponding to the object, wherein keypoint interpolation comprises exclusion of 3D keypoints that are within a proximity range of depth edges of the object.

10. The method of claim 1, wherein the tracked positions of the device identify position and orientation of the device with respect to the coordinate system defined based on the position and the orientation of the object.

11. The method of claim 1, wherein the device comprises a user interface, wherein tracking positions of the device during acquisition of the images comprises displaying guiding indicators on the user interface to guide moving the device to a new position to acquire additional images of the object at the new position, wherein the guiding indicators guide moving the device to the new position and a new orientation, wherein the guiding indicators are positioned in 3D space in a live camera view of the device.

12. The method of claim 11, wherein, when the object moves within a field of view of the camera of the device, the guiding indicators are moved with respect to the object based on an adjusted coordinate system defined based on an adjusted position and an adjusted orientation of the object, wherein the adjusted position and the adjusted orientation of the object are based on the movement of the object.

13. The method of claim 1, wherein tracking the positions of the device comprises adjusting the images of the physical environment using:
a two-dimensional (2D) mask to remove background image pixels of the images, wherein the 2D mask is determined based on the coordinate system of the object; or
a 3D bounding box constraint to remove background image pixels of the images, wherein the 3D bounding box constraint is determined based on the coordinate system of the object.

14. The method of claim 1, wherein the sensor data comprises depth information that includes a sparse 3D point cloud for each image, wherein tracking the positions of the device comprises adjusting the images of the physical environment based on a densification of the sparse 3D point clouds based on 3D keypoints corresponding to the object.

15. The method of claim 1, wherein, when the object is reoriented or repositioned within a field of view of the camera, the method further comprises a relocalization process, the relocalization process comprising:
comparing a first image of the physical environment with a plurality of keyframe images of the object, the first image comprising the object;
identifying a first keyframe from the plurality of keyframes based on the comparing, the keyframe associated with a first keyframe position in the coordinate system; and
based on identifying the first keyframe, determining a re-localized position of the device with respect to the coordinate system of the object during acquisition of the first image based on the first keyframe position.

16. The method of claim 15, wherein the object is reoriented or repositioned within the field of view of the camera following a period in which the object is not within the field of view of the camera.

17. The method of claim 1, wherein the generated 3D model of the object is determined based on refined images, wherein the refined images are determined based on at least one of a 3D keypoint interpolation, densification of 3D sparse point clouds associated with the images, a two-dimensional (2D) mask corresponding to the object to remove background image pixels of the images, a 3D bounding box constraint corresponding to the object to remove background image pixels of the images.

18. The method of claim 17, wherein the 3D keypoint interpolation, the densification of the 3D sparse point clouds, the 2D mask, and the 3D bounding box constraint are based on the coordinate system of the object.

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
acquiring sensor data during movement of the device in a physical environment comprising an object, the sensor data comprising images of the physical environment acquired via a camera on the device;
identifying the object in at least some of the images;
tracking positions of the device during acquisition of the images based on identifying the object in the at least some of the images, the positions identifying positioning of the device with respect to a coordinate system defined based on a position and orientation of the object; and
generating a three-dimensional (3D) model of the object based on the images and positions of the device during acquisition of the images.

20. A non-transitory computer-readable storage medium, storing computer-executable program instructions on a computer to perform operations comprising:
acquiring sensor data during movement of the device in a physical environment comprising an object, the sensor data comprising images of the physical environment acquired via a camera on the device;
identifying the object in at least some of the images;
tracking positions of the device during acquisition of the images based on identifying the object in the at least some of the images, the positions identifying positioning of the device with respect to a coordinate system defined based on a position and orientation of the object; and
generating a three-dimensional (3D) model of the object based on the images and positions of the device during acquisition of the images.
